(19) United States
(12) Patent Application Publication
(10) Pub. No.: US 2014/0129680 A1
(43) Pub. Date: May 8, 2014

(54) SOCKET COMMUNICATION APPARATUS AND METHOD

(71) Applicant: BITGRAVITY, INC., Burlingame, CA (US)

(72) Inventor: Samik Mukherjee, Fremont, CA (US)

(73) Assignee: BITGRAVITY, INC., Burlingame, CA (US)

(21) Appl. No.: 13/671,881

(22) Filed: Nov. 8, 2012

(51) Int. Cl. G06F 15/16

(52) U.S. Cl. 709/219

(57) ABSTRACT

A method of grouping streaming content by a server. The method includes receiving a first request from a first client device and a second request from a second client device for an event to be streamed. Providing streaming content for the event. Determining the frame boundaries of the streaming content to be delivered to the first client device. Determining the frame boundaries of the streaming content to be delivered to the second client device. Grouping together the streaming content for the first client device and the second client device when the frame boundaries of the first client device and the second client device are determined be within a predetermined range.

### BACKGROUND

The following description sets forth the inventor's knowledge of related art and problems therein and should not be construed as an admission of knowledge in the prior art.

Live video streaming is becoming increasingly popular among Internet users. Users stream live events such as sporting events, news events, and other current events in real time. Users stream these live videos to their mobile devices, desktop computers, laptop computers, etc.

Streaming content typically represents information that must be delivered in real time. This information could be, for example, video, audio, slide show, web tour, combinations of these, or any other real time application. (Examples of types of media files include: Moving Picture Experts Group (MPEG), QuickTime™ video files, WINDOWS Media Video (WMV), Audio Video Interleave (AVI), etc. Audio files include MPEG-4, WAY, MP3, etc. Examples of image file formats include: JPEG, GIF, BMP, TIFF, etc.).

Heretofore, a typical live streaming process would operate in the following manner. First a live video stream is sent to an ingest site (origin server). The origin server distributes the live video stream to edge nodes, or edge servers. The edge servers receive requests for the live video event and then distribute the live video event to each requesting user. Edge servers can serve multiple requesting devices, including thousands of requesting devices at a single time.

As shown in FIG. 10, an origin server 5 provides a live video stream 100 to an edge server 9. The edge server 9 buffers the live video stream in a buffer 38. The edge server then individually serves each requesting client device 15 by providing the requesting client device 15 the live video stream.

As shown in FIG. 10, for example, a requesting client device 15a makes a request to receive live streaming content. The requesting client device 15a is connected to the edge server 9 through socket 34. The kernel of the edge server 9, which manages edge server 9 resources, determines the appropriate live stream data to write to the requesting device 15a. The kernel reads the buffer memory 38 and writes the appropriate live streaming content to the requesting client 15a.

The kernel then services the request of the next requesting client device, 15b. The kernel determines the appropriate live streaming data to deliver to the requesting client device 15b and reads the buffer memory 38 and writes the appropriate live streaming content data to the requesting client device 15b.

The kernel provides each unique requesting client device 15 with the live streaming data until each requesting client device 15 has been served. The kernel separately accesses the buffered live streaming content for each requesting client device 15.

### SUMMARY

The inventor of the present application noticed that the efficiency of the edge servers was well below a maximum efficiency in delivering live streaming data. In some instances, the efficiency of the edge servers was 50%. That is, the edge servers could only output live streaming data at 50% of the output capacity.

For example, if the edge server was capable of outputting 10 Gbps of live streaming data, it was found that the edge server was only outputting 5 Gbps in some circumstances. A lower efficiency means that more edge servers are needed to output the required data. This results in an increased cost as more hardware (e.g. edge servers) and more maintenance is required to output a given amount of data.

The inventor discovered that this inefficient delivery of live streaming data was caused in part by the kernel of the operating system of the edge server 10. The kernel manages the interactions between the applications running on the edge server (e.g. the live streaming applications), and the hardware of the server. Hardware of the edge server 10 and client devices 15 are discussed in FIG. 9 below.

The kernel managing the live streaming applications was found to cause the lowered data output efficiency of the edge server. It was found that each request for streaming content, among the hundreds or thousands of requests, slowed down the kernel due to a large amount of redundant data processing. The inventor discovered that if the kernel could eliminate the redundant data processing, an edge server efficiency of 80%-90% could be achieved.

Experimental data gathered by the inventor shows that an edge server efficiency of 90% was achieved by modifying the kernel operations and eliminating redundant data process. Thus, if an edge server video card 180 had a maximum output capacity of 10 Gbps, using the present invention, the edge server video card 180 could output 9 Gbps.

The increased edge server output results in an efficiency increase of 80%. Therefore more live streaming data can be served to requesting client devices 15 by an edge server 10. This results in reduced operating cost due to savings in hardware and maintenance.

The details of how the edge server 10 provides live streaming content to the requesting client devices 15 are discussed in more detail below.

### BRIEF DESCRIPTION OF DRAWINGS

The advantages of the invention will become apparent in the following description taken in conjunction with the drawings, wherein:

FIG. 1 illustrates a content distribution network providing live streaming content to requesting devices;

FIG. 2 illustrates a flowchart of an embodiment for streaming live data to multiple users;

FIG. 3 illustrates an Internet protocol stack;

FIG. 4 illustrates client devices requesting live streaming content from an edge server;

FIG. 5 illustrates the timing of live data streams;

FIG. 6 illustrates grouping a live video streams to client devices;

FIG. 7 is a flowchart showing how multiple live data streams can be grouped together;

FIG. 8 is a flowchart showing how data can be written to grouped data streams;

FIG. 9 illustrates a schematic of an edge server connected through a network to a client device; and

FIG. 10 illustrates a known method of providing live streaming content to multiple client devices.

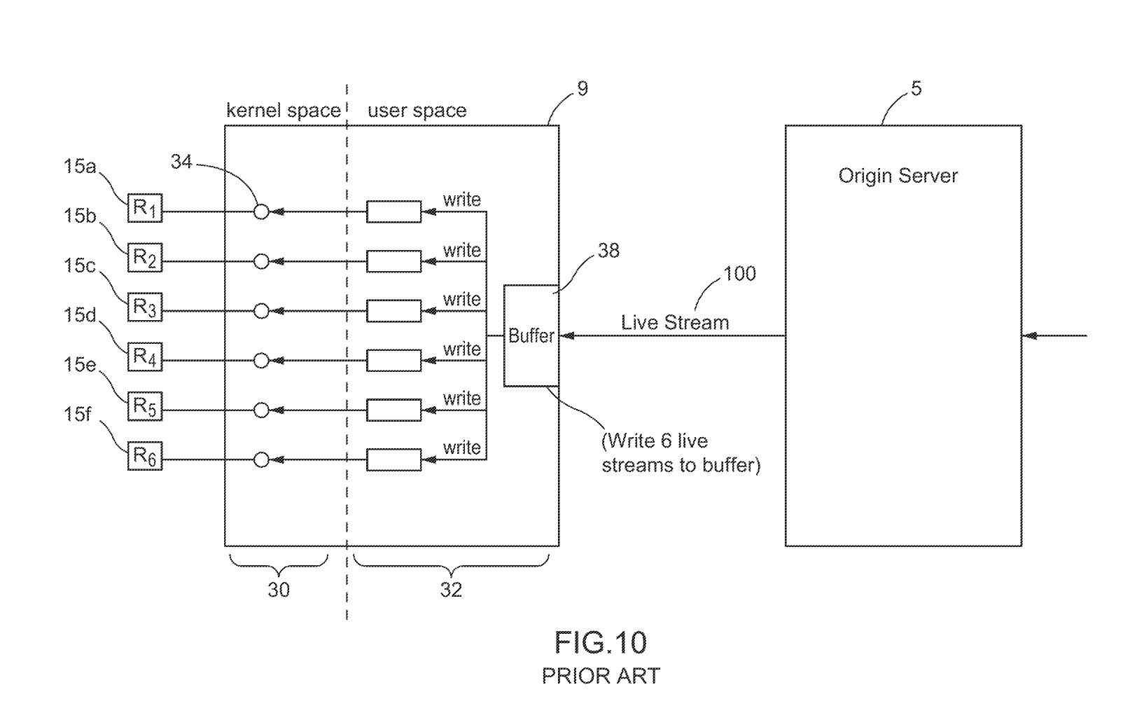

### DETAILED DESCRIPTION OF DRAWINGS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

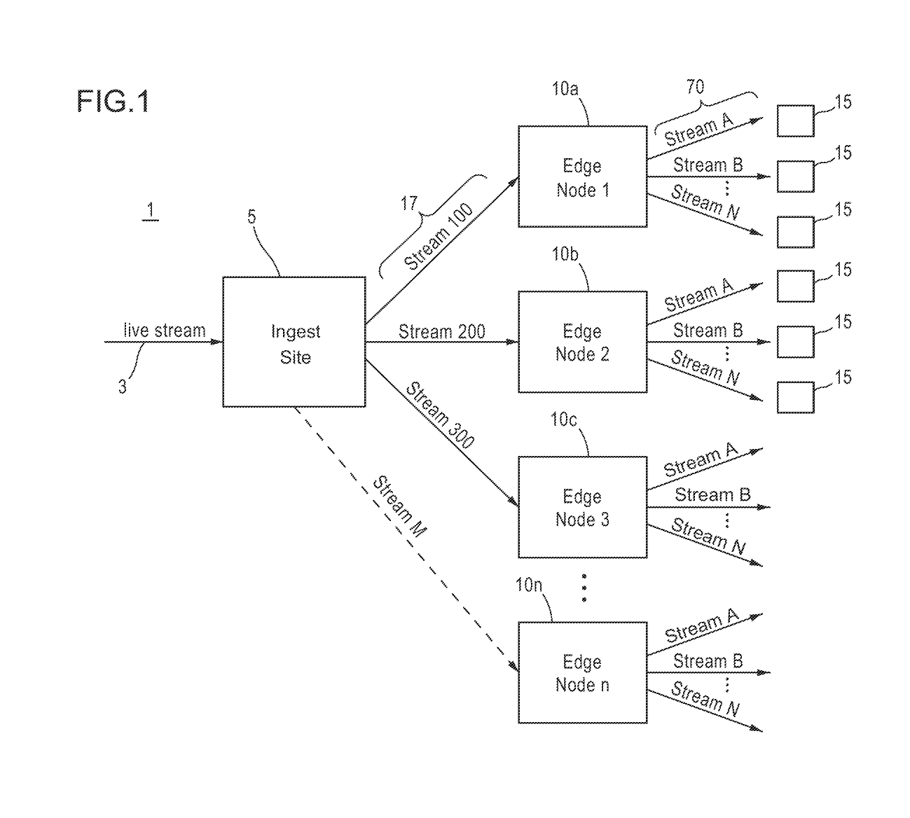

A portion of a content distribution network (CDN) 1 is illustrated in the embodiment depicted in FIG. 1. A live stream 3 is delivered to an ingest site 5 (origin server) and to client device (15). (For example a live stream can be media content (e.g. video, audio, etc.), data content, a live video stream, streaming data, etc.) Alternatively, a stream 3 comprising pre-recorded or live content, and may be sent to the respective client device(s) 15.

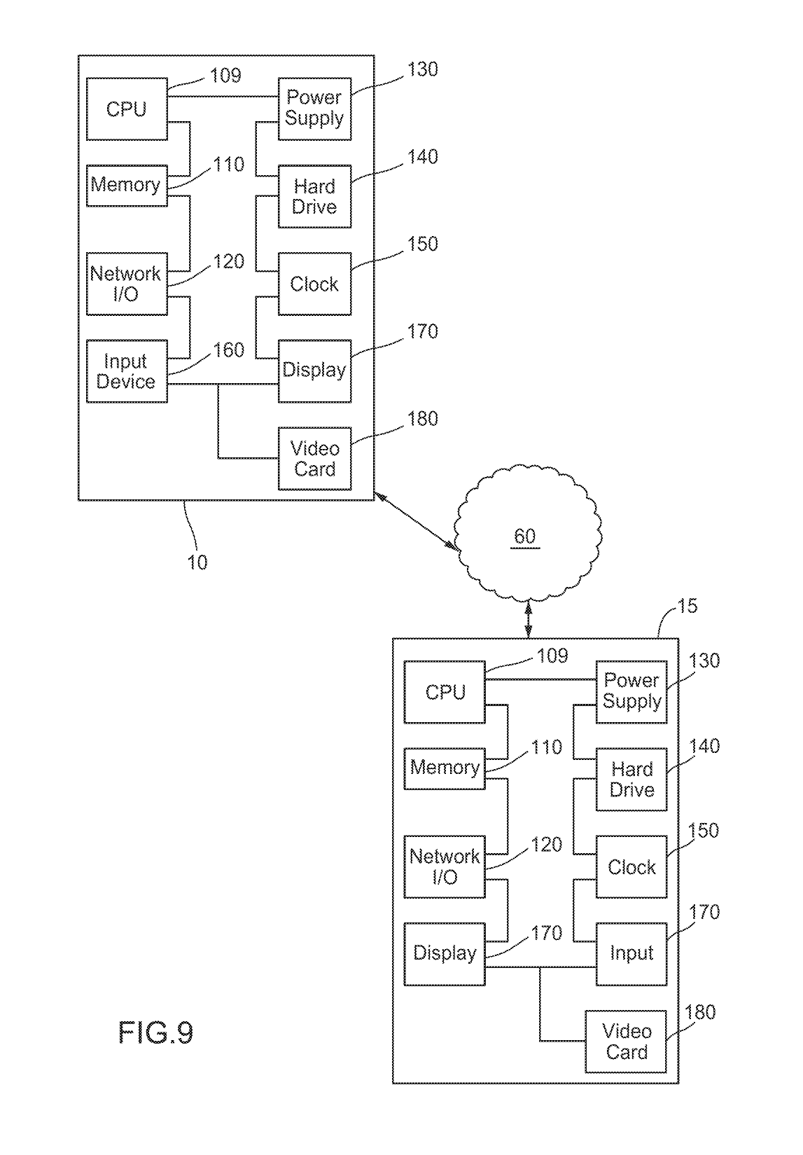

Live stream 3 is delivered from an originating content provider (not shown) such as an entity that is recording a live event (e.g. a sporting event, a news event, etc.). The live stream 3 can be delivered over a network 60 (e.g. Internet, WAN, LAN, etc., shown in FIG. 9). The live stream 3 is duplicated by the origin server 5 and sent to edge server(s) 10a-n over the network 60.

Edge servers 10 provide live streaming content to each requesting client device 15 through live streams 70 over network 60. A client device 15 could be any device that is requesting streaming media (or any type of data) content from an edge server 10. For example, a client device 15 could be a desktop computer, laptop computer, mobile device, server, etc. Edge servers 10 can be positioned throughout a geographic region and even throughout the world if necessary. This allows the edge servers 10 to be positioned closer to the requesting client device 15.

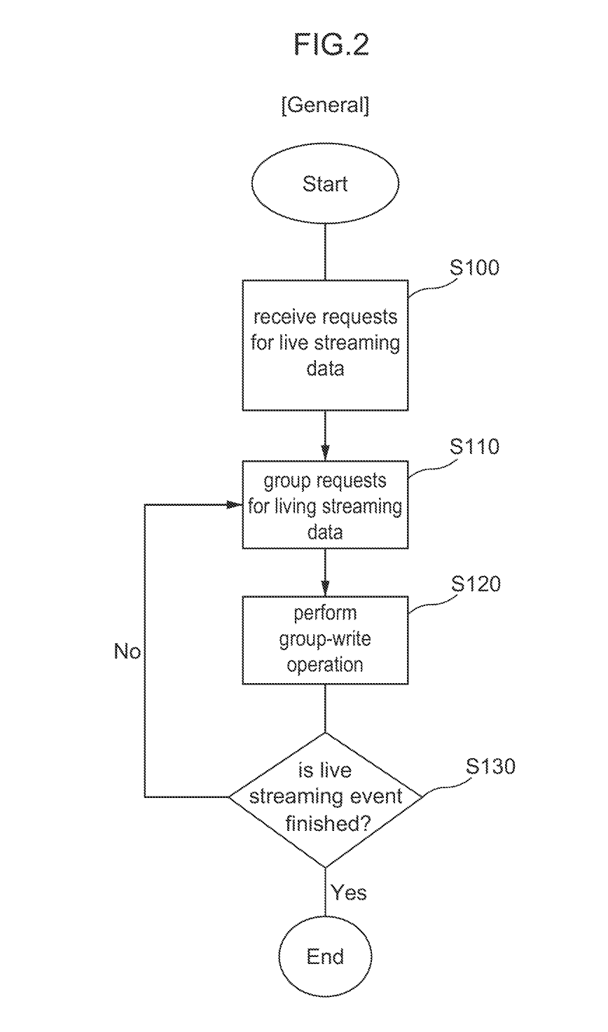

As shown in FIG. 2, the edge server 10 receives requests for live streaming data in step S100. The number of requests can range anywhere from a single request to thousands or tens of thousands of requests for the same live streaming content. Upon receiving, for example, multiple requests in step S100, the edge server 10 determines which requests can be grouped together in step S110. That is, a group of requests can be grouped together if they share identical or similar frame boundaries. When a video stream is transmitted digitally, it is broken into groups of still pictures, each of which is a frame. The frame boundaries, in the present context, can be the start and end locations of the memory 110 that represent a still picture.

Once the requests have been grouped together in step S110, streams of data are grouped (e.g. grouped stream 70) by the edge server 10. Each grouped stream 70 undergoes a group-write operation in step 120. The edge server fetches the next block of data from the memory 110 to be transmitted for this grouped stream 70 and then does a group-write operation in step S120. The edge server 10 can access a memory 110 (e.g. buffer 38) a single time and perform multiple write and copy operations based off this single access to memory 110. Each grouped stream 70 can serve anywhere from one client device 15 to tens of thousands of client devices 15. Thus, the live streaming data 3 can be copied and written to hundreds, thousands or tens of thousands of requesting client devices 15 without having to access memory 110 more than a single time.

Once every client device 15 of each grouped stream 70 has received the live streaming data, the edge server 10 determines whether the live streaming event is finished in step S130. If the live streaming event is over, then the process stops. If the live streaming event is not over, then the process reverts back to step S110 to group the live media/data streams and repeat the process again until the event has finally ended.

A more detailed discussion of the various steps illustrated in FIG. 2 will be discussed below.

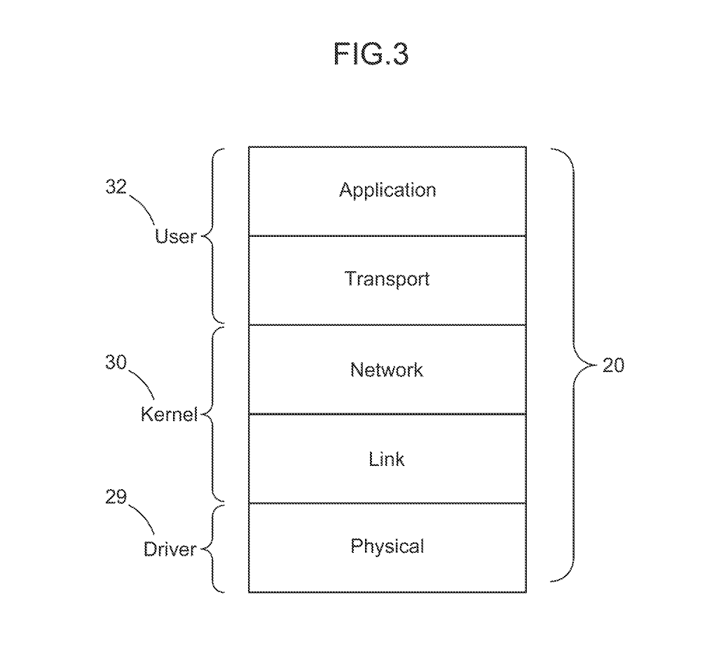

FIG. 3 shows an Internet protocol stack 20. Internet protocol stack 20 represents 5 protocol layers, which can be divided into three distinct groups. The application layer and transport layer can be grouped into a user space 32. The application layer is used by the live streaming program which uses data transported using the transport layer. Live streaming applications can include RTSP (real time streaming protocol), RTMP (real time messaging protocol), FLASH, or any other suitable live streaming application.

Kernel space 30 includes a network layer and a link layer. The kernel is the main component of most operating systems and manages the physical resources of computing devices for the different applications running on the computing device.

Driver 29 manages the physical layer within the Internet stack.

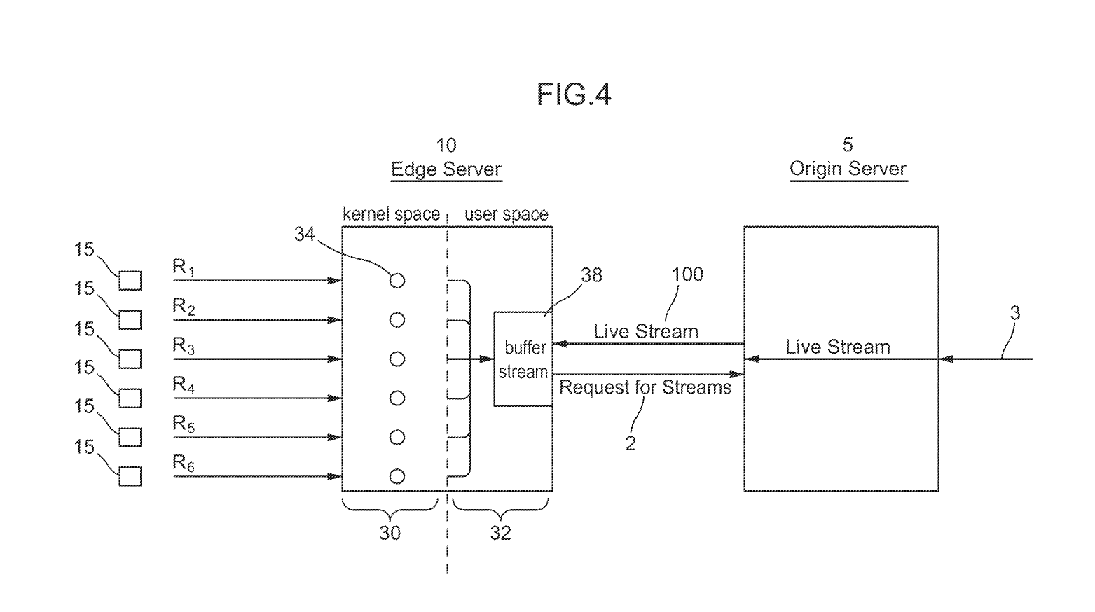

FIG. 4 illustrates an example of a plurality of client devices 15 making a request for the same live streaming media content from edge server 10. As shown in FIG. 4, edge server 10 is divided into two separate sections for illustration purposes, kernel space 30 and user space 32. Each requesting client device 15 is connected to the edge server 10 by a socket 34. A socket, for example, is an endpoint of a communication link at the edge server, which establishes communication between the client device 15 and the edge server 10. Each socket 34 has its own unique address scheme within the edge server 10.

Each client device 15 communicates with the edge server 10 using a specific socket 34. Each request by client device 15 for the same live video stream 100 is sent from the kernel space 30 to the user space 32 where a live video stream 100 is stored in memory 110 (e.g. buffer 38). The edge server 10 then provides each client device 15 with the requested live video stream. This is discussed in further detail below.

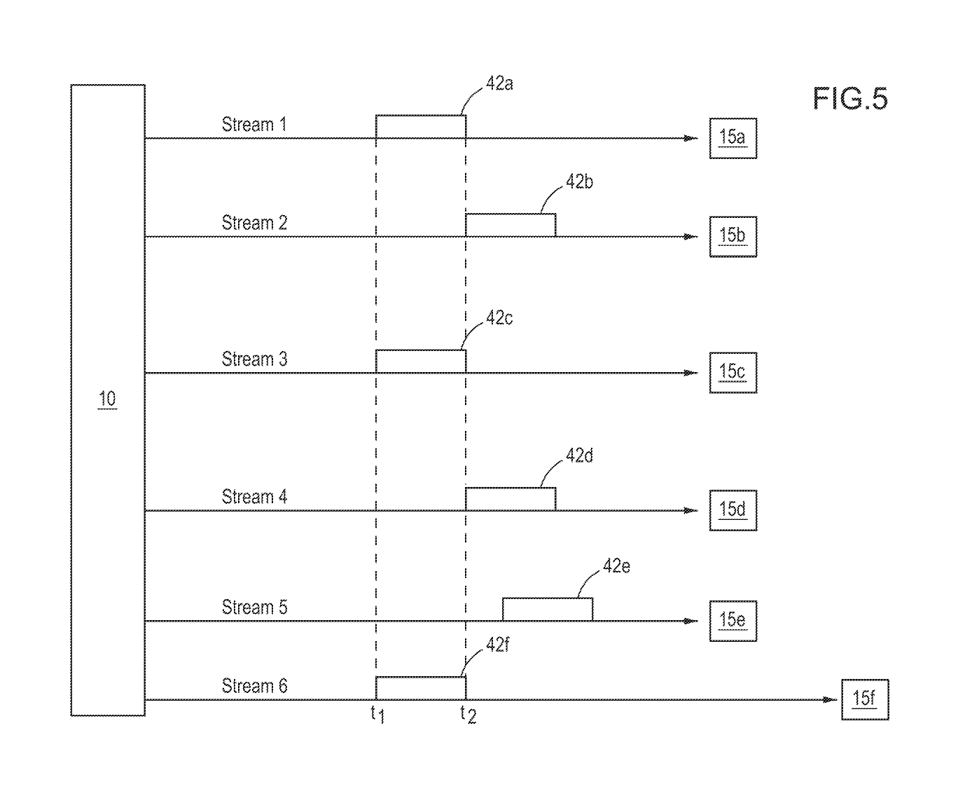

FIG. 5 shows an example of content data being sent or streamed to multiple requesting client devices 15 from edge server 10. Data packets 42 are shown being sent from edge server 10 to each of the requesting client devices 15. In a live streaming event, data packets 42 are delivered from the edge server 10 after they have been stored in the memory 110 (e.g. buffer 38). However, due to several factors, the live stream data packets 42 for each client may not be delivered at identical times. That is, the data packets 42 may be delayed before being delivered to the client device 15.

One reason for the delay may be that each client 15 device has its own particular bandwidth, which may be different than the bandwidth of another client device 15. In the present example, the bandwidth refers to a connection speed between the client device 15 and the edge server 10.

Another reason may be due to a resolution of the media content. That is, the respective client devices 15 may each stream the media content at different bitrates (e.g. a high bitrate with a high resolution, a low bitrate with a low resolution, etc.).

An additional reason may be that the requesting client device 15 cannot process the live stream data 42 quickly enough. For example, each client 15 may have an input buffer that buffers the live stream packets data 42. If the client device 15 cannot process the live stream packets data 42 as quickly as they are sent by the edge server 10, then the buffer of the client device 15 will become full.

Each of the live stream data packets 42 has a pair of frame boundaries (e.g. a front frame boundary b1 and a rear frame boundary b2). The frame boundaries can be used, for example, to determine whether the respective client devices 15 are at the same point (or similar points) in the live stream event as other client devices 15. For example a live stream event may be at frames 10,000 to 10,100. Thus the front frame boundary would be 10,000 and the rear frame boundary would be at 10,100.

A similar point in the live streaming event is any point in which the frame boundaries of the respective streams are not more than, for example, 10 frames apart. As shown in FIG. 5, stream 1 and stream 3 have the same front frame boundary and the same rear frame boundary.

However, although the client device 15b receiving stream 2 is receiving the same live streaming event as the client device 15a receiving stream 1, client device 15a receiving stream 2 receives a delayed live stream data packet 42 compared to client device 15b receiving stream 1.

If the buffer of a client device 15 is full and the edge server 10 continues to send live stream packets 42 to the client device 15, data will be lost. As such, the edge server 10 can withhold or delay sending the live stream data packets 42 to the client device 15. Therefore even though two client devices 15 are live streaming the same event, they can receive the live streaming data packets 42 at different times. The edge server 10 keeps track of each client device's 15 position in the streaming video memory buffer during the entire live streaming event.

Grouping live streams which receive the live stream data packets 42 at the same or similar times is further discussed below.

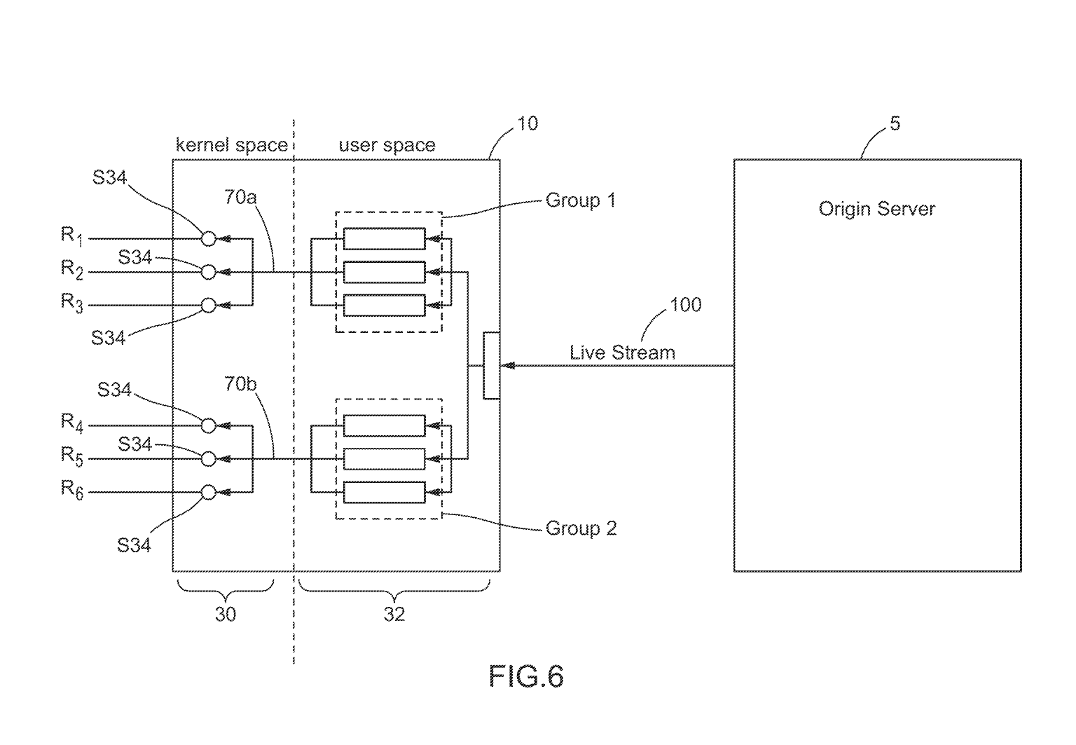

FIG. 6 shows an example of two sets of live stream packets 42 grouped together (e.g. grouped stream 70a and grouped stream 70b). To improve efficiency of the edge server 10, client devices 15, which will receive identical or similar live stream data packets 42, can be grouped together. The grouping of similar streams is performed in the application layer (shown in FIG. 3) so that copies from the application (memory) space to kernel (memory) space are done in parallel. This reduces the number of context switches.

A context switch in this case refers to the operating system switching its mode of operation from user space to kernel space to allow it to push memory buffers onto the network sockets for transmission. Context switching requires the operating system to perform considerable amount of administrative tasks to save the state of the current context and then load the previous state of another context into its memory and registers. Since these administrative tasks require CPU resources, the system's efficiency becomes inversely proportional to the number of context switches executed. In the present instance, by performing the memory buffer writes in groups, it reduces the number of context switches required and hence increases efficiency.

In one embodiment, the client devices 15 are grouped together by determining the frame boundaries of the live stream data packets 42 to be delivered to the client devices 15. The frame boundaries of the different data streams to be sent to the respective client devices 15 can be compared periodically (e.g. every second, every 5 second, every 10 seconds, every 30 seconds, etc.). Further, the frame boundaries can be determined dynamically (e.g. at different time intervals, by the number of frames that have be sent to the client devices 10, or any other suitable way).

If the edge server 10 determines that the streams provided to any of the client devices 15 have the same or similar frame boundaries, then the streams can be grouped together. Although FIG. 6 shows only two sets of streams being grouped together, the present embodiment is not limited to two. Many hundreds or thousands or hundreds of thousands of streams can be grouped together, and there could be hundreds of thousands of grouped streams.

In one embodiment, the buffer 38 contains the frame boundaries. That is, the front frame boundary can be the first data memory address in the buffer 38 and the ending frame boundary can be the last data memory address in the buffer 38. As the origin server 5 delivers live streaming content 100 to the edge server 10, the content is temporarily stored in the buffer 38. When new data is saved into the buffer 38 (e.g., temporary memory), the new beginning and end frames stored in the buffer 38 become the new frame boundaries. The edge server 10 can then check the new frame boundaries to determine how to group the various data streams.

The grouping of the data streams can dynamically change throughout the live streaming broadcast. As client device devices 15 incur varying bandwidth, internal buffer variations, change in content quality, etc., the client devices 15 may be grouped, for live streaming purposes, in different streamed group 70 throughout the live streaming event.

In one example, a client device 15 is initially grouped in a first group which is 2 seconds behind the actual live stream feed 100 coming from the origin server 5. Upon receiving new live stream data in the buffer memory 38, the edge server 10 checks the status (e.g., frame boundary information) of each client device 15 to determine what data streams for the client devices 15 can be grouped together. At a point later in the live streaming event, the same client device 15 is 5 seconds behind the live stream 100 from the origin server 5. This client device 15 is then grouped in a different grouped stream 70 where each of the other client devices 15 is similarly 5 seconds behind the live stream 100.

In another example, the requesting client device 15 falls behind in receiving the live stream data from the edge server 10 (e.g. 5 seconds, 10 seconds, 20 seconds, 60 seconds, 120 seconds, etc.). The edge server 10 then cuts off the live streaming data (now 5, 10, 20, 60, 120 seconds delayed, etc.) being sent to client device 15 and skips to the current live streaming data (e.g. no delay). When this happens the client device 15 loses a portion of the live streaming data, but becomes current in the live streaming video feed.

For example, if the client device 15 was live streaming a football game and was at the 5:00 minute mark in the game, but the actual live streaming event was already at the 8:00 minute mark, then the edge server 10 would cut off the delayed live streaming feed to the client device 15 at the 5:00 minute mark and jump to the current live feed at the 8:00 minute mark. The client device 15 would lose 3:00 minutes of data (from the 5:00 minute mark to the 8:00 minute mark). However, the client device 15 would be receiving the live streaming video feed, or a video feed without a time delay (or a smaller time delay).

As each client device 15 can receive the streaming content at different rates at any given moment, and client devices 15 can fall too far behind a streaming feed, client devices 15 can be grouped into different streams, e.g. dynamic grouping, throughout the course of the streaming event.

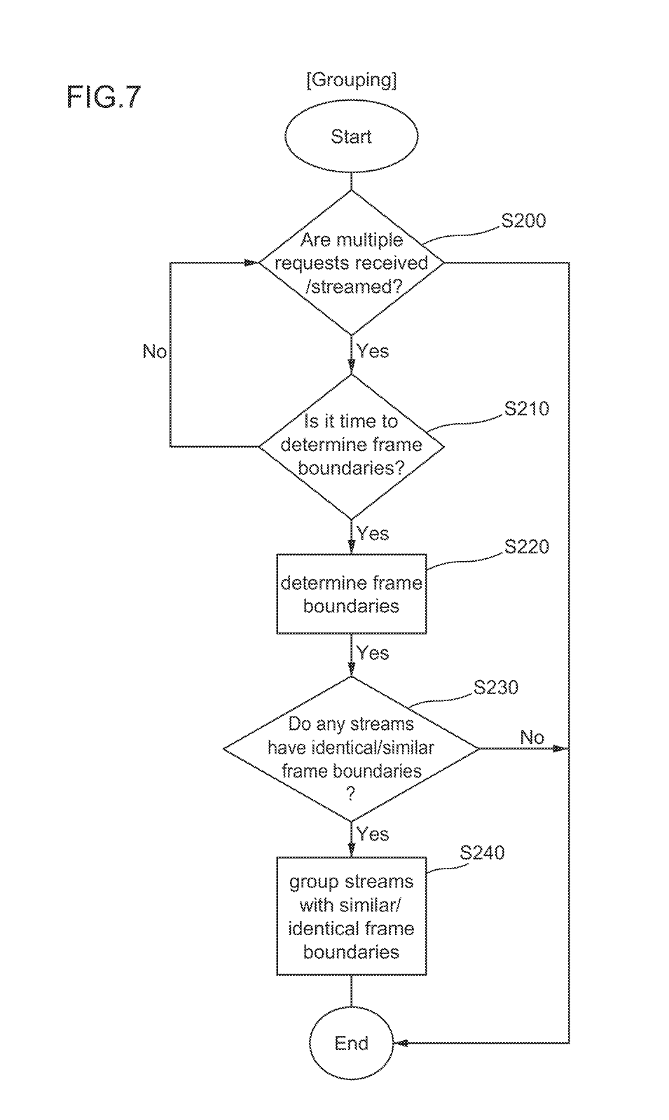

FIG. 7 is a flowchart illustrating one embodiment of how live streams 70 can be grouped together. Steps S200 through S240 can each occur within step S110 as shown in FIG. 2. To begin the grouping process, edge server 10 first determines whether multiple live streaming requests have been received, or are currently being serviced. That is, before a live streaming event begins, each client device 15 will be starting from the identical frame boundaries and will receive exactly the same streaming content (for client devices streaming the same bitrate file).

If the edge server 10 determines that multiple requests or video streams are being received in step S200, then the edge server 10 decides whether it is time to determine the frame boundaries of the streamed content for each client device 15 in step S210. If the edge server 10 determines that multiple requests are not being received or that multiple live video streams are not being sent to the client devices 15, then the process ends.

As discussed above, the edge server 10 can check the frame boundaries of the streamed content when the memory 110 (e.g. buffer 38) of the edge server 10 is refreshed or rewritten. Alternatively, the edge server 10 can check the frame boundaries of the streamed content periodically for a given amount of time. Alternatively, the edge server 10 can check for when a certain number of frames have been streamed to the client device 15.

If the edge server 10 determines that it is not time to check the frame boundaries, then the process returns to step S200. If the edge server 10 determines in step S210 that it is time to check the frame boundaries, then the process proceeds to step S220. In step S220, the edge server 10 checks the frame boundaries and determines the front frame boundary and the rear frame boundary. Alternatively, the edge server 10 could check for only a front frame boundary or a rear frame boundary.

In step S230 the edge server 10 determines whether any of the client devices 15 have the same or similar frame boundaries with respect to the frame boundaries of the streaming media content. The client devices 15 that have the same or similar frame boundaries with respect to the frame boundaries of the streaming media content are grouped together in step S240. If no client devices 15 have the same or similar frame boundaries then the process ends. The grouped streams 70 can serve two client devices 15, or thousands of client devices 15. Once all of the media content streams for each client device 15 that can be grouped together are consolidated into grouped streams 70, the grouping process ends (in this subroutine).

Once the media streams are grouped together in step S240, the edger server 10 then performs a “group-write” operation to each of the requesting client devices 15 (e.g., the appropriate socket to which each client device 15 is associated with.) In one embodiment, a group-write operation means performing two or more write operations to sockets associated with two or more client devices 15, respectively, from a single occurrence of reading memory from memory 110. An example of this feature is illustrated in FIG. 6 on left hand side of the dotted line in kernel space 30. Performing a group-write operation from one data memory address to many requesting client devices 15 allows the edge server 10 to much more efficiently process requests for live video streams.

It should be appreciated that such a group-write operation is not limited to the CDN context and can be applied to any situation where a kernel can write the same data to two or more sockets.

As shown in FIG. 6, the edge server 10 is divided into kernel space 30 and user space 32. The kernel manages the interactions between the applications running on the edge server (e.g. the live streaming applications), and the hardware of the server. The hardware of the edge server can include the central processing unit (CPU), memory and the input/output devices.

In one embodiment, the kernel of the edge server 10 performs a group-write operation for all of the requesting client devices that are grouped together in the grouped streams 70. By fetching the live streaming data from memory 110 only once (for a given write operation for a grouped stream 70), this saves time and processing resources.

Previously, a kernel would have to perform n number of fetch operations from memory 110 and n number of write operations for n number of client devices 15. In other words, when a client devices 15a-15n would request the live video feed, the kernel would individually serve each requesting device, reading from the buffer memory 38 n times and writing to the client devices n times. In the present embodiment, the kernel fetches the live streaming data 100 from the buffer memory 38 one time and can perform two or more, hundreds or thousands of write operations to the sockets associated with (depending on the size of the group) client devices 15.

Through experimentation the inventor has found that by grouping client devices 15 together and performing a write operation based on the grouping (and not the individual client device), efficiency of the edge server can be improved from 50% utilization to 90% utilization. That is, if an edge server 10 could have a theoretical maximum output data rate of 10 Gbps, under the previous method, the edge server would only output 5 Gbps. In the embodiment discussed above, the edge server can output data at 9 Gbps.

One reason for the improved efficiency gain is due in part to the reduced overhead cost of processing by the kernel. Instead of fetching the pertinent data in the buffer memory 38 for each client device 15 being served, the edge server 10 now only needs to look up the pertinent data for each grouped stream of client devices 15. Thus, if there were 10 client devices per group, the kernel would have a processing savings of 10 times (e.g. only looking up the pertinent data once instead of 10 times).

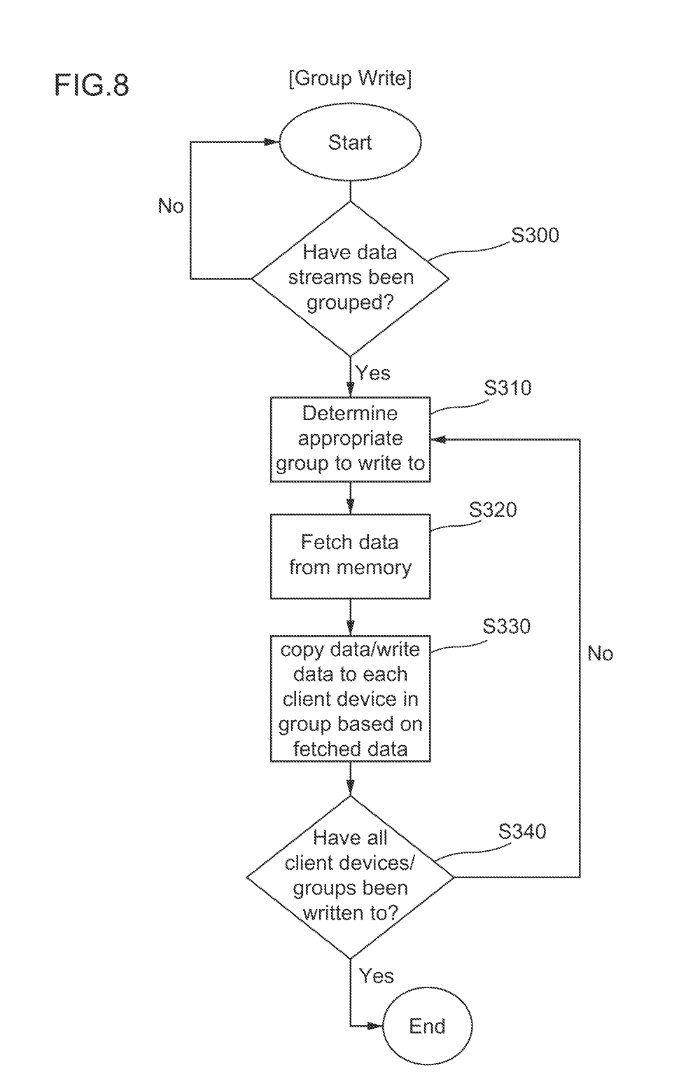

FIG. 8 illustrates an example of a group-write operation. Steps S300 through S340 can each occur within step S120 as shown in FIG. 2. As shown in step S300, the edge server 10 first determines whether the client devices 15 have been grouped together to form grouped streams 70, as discussed above with respect to FIG. 2.

If the individual client devices 15 have been grouped together to form grouped streams 70, then the edge server 10 proceeds to step S310. If the individual client devices 15 have not been consolidated to form grouped streams 70, then the edge server goes back to the start of the process.

As shown in step S310, the edge server chooses an appropriate grouped stream 70 to write to the appropriate sockets. As shown in FIG. 6, only two grouped streams 70a and 70b are shown; however, thousands of grouped streams 70 could be possible for a given edge server 10.

Once a grouped stream 70 is selected to be written to the appropriate sockets, the edge server 10 fetches the live streaming data 100 from a memory (e.g. buffer 38) in step S320. Next the edge server 10 writes the live streaming data 100 to each of the sockets associated with the client devices 15 in the grouped stream 70. For example, the live streaming data 100 can be provided to the socket 34 for each client device 15 in the kernel space 30.

The fetched live streaming data for a grouped stream 70 is copied n−1 times, wherein n is the number of client devices 15. This copying feature saves the kernel of the edge server 10 from having to repeatedly access the memory each time the live streaming data is written to the specific client device 15. By performing a group-write to the client devices 15, resources can be saved by the kernel and increased efficiency can be achieved.

Once all of the client devices 15 of the selected grouped stream 70 are written to, the edge server 10 writes the live streaming data to the client devices 15 of the next selected group and so on. As shown in step S340, the edge server 10 determines whether all of the client devices 15 of the grouped streams 70 have been written to. If not all of the client devices 15 in each of the grouped streams 70 have been written to, the edge server repeats the process and proceeds to step S310. If all of the client devices 15 of each of the grouped streams 70 have been written to, the group-write subroutine finishes.

Because the efficiency of the edge servers can be nearly doubled, the amount of hardware needed to stream live content can be significantly reduced. This also leads to a greater cost savings in setting up and maintaining any content distribution network used for live streaming data.

In one embodiment, the client device 15 can be an edge server 10 in CDN 1 and the above described techniques can be used to update files in a distributed file sync operation. The origin server 5 can use the techniques described above to distribute data to each client device 15. For example, if data from origin server 5 is updated and needs to be distributed to other edge servers 10, the origin server 1 can follow the process as set forth in FIG. 2, discussed above.

The origin server 5 can perform the distributed file sync operation to each requesting client device (e.g. edge servers 10) at the same time, or at similar times. As set forth in FIG. 2, the edge servers 10 can be grouped together and a more efficient updating operation can be performed by the origin server 5.

In the above example, the edge servers 10 can be the requesting client devices 15 and the origin server 5 can be the edge serer 10 as shown in FIG. 1. As the same information is to be sent to each requesting edge server 10, an increased efficiency of transferring data to requesting devices can be attained.

By performing updating operations using the above described techniques, this prevents constant syncing operations from having to be performed. This reduces the resources that are consumed by the constant syncing operations and frees up more resources to serve clients.

FIG. 9 shows an example of the hardware and interconnectivity between edge server 10 and a client device 15. As shown in FIG. 9, an edge server 10 can include a central processing unit (CPU) 109. CPU 109 can perform all of some of the computing processes required by edge server 10. Further CPU 109 is not limited to one processor but could be a plurality of processors which perform the processing duties.

CPU 109 is interconnected to memory 110. Memory 109 could be for example, random access memory (RAM) and could store information required by the CPU 109. CPU 109 and memory 110 can be interconnected to a network interface 120. Network interface 120 can facilitate communication between edge server 10 and other devices connected to network 60. Network interface 120 could connect to network 60 using any of a number of known communication methods.

Input device 160 can be a mouse, keyboard, etc., and is used to input data to the server. Power supply 130 powers the server. Hard drive 140 can provide a non-volatile memory for server 10. Clock 150 can be used by the CPU 109 and other devices and provides a fixed frequency of oscillation. Display 170 can be a liquid crystal display, plasma display, or any other suitable viewing display.

Client device 15 can contain similar units as described above in the edge server 10. Further, an input on a client device 15 may be a touch-screen or the like.

Network 60 can be a local area network (LAN), wide area network (WAN), or the Internet, for example.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

While embodiments of the present disclosure have been particularly shown and described with reference to exemplary embodiments thereof, it will be understood by those of ordinary skill in the art that various changes in form and details may be made therein without departing from the spirit and scope of the present invention as defined by the following claims.

We claim:

1. A method of grouping streaming content by a server, said method comprising:
receiving, by the server, a first request from a first client device and a second request from a second client device for streaming content;
determining, by the server, a first frame boundary of the streaming content to be delivered to said first client device;
determining, by the server, a second frame boundary of the streaming content to be delivered to said second client device;
grouping together, by the server, the streaming content for said first client device and said second client device when the first frame boundary and the second frame boundary are determined be within a predetermined range; and
providing, by the server, the streaming content to said first client device and said second client device.

2. The method according to claim 1, wherein said predetermined range is a predetermined number of frames.

3. The method according to claim 1, wherein determining the first frame boundary and the second frame boundary occurs when a memory buffer of the server is rewritten with new streaming content.

4. The method according to claim 1, wherein said grouping together streaming content for said first and second client devices occurs when a memory buffer of the server is rewritten with new streaming content that is different from previous streaming content.

5. The method according to claim 1, wherein said determination of said first and second frame boundaries is determined by determining whether said first and second frame boundaries are within a predetermined period of time of one another.

6. The method according to claim 1, wherein said determination of said first and second frame boundaries is determined by determining whether or not said frame boundaries are within a predetermined number of frames of one another.

7. The method according to claim 1, further comprising:
receiving, by the server, a third request from a third client device for the streaming content;
determining, by the server, a third frame boundary of the streaming content for said third client device;
grouping together, by the server, the streaming content for said first, second, and third client devices when the frame boundaries of said first, second, and third client devices are determined to be within a predetermined range;
not grouping together the streaming content for said third client device with said first and second client device when said third frame boundary is not within a predetermined range of the first and second frame boundaries; and
providing streaming content, by the server, to said third client device.

8. A method of streaming content by a server, said method comprising:
receiving, by the server, a first request from a first client device and a second request from a second client device for streaming content;
determining, by the server, the frame boundaries of the streaming content for said first client device and said second client device;
grouping together streaming content, by the server, for said first client device and said second client device into a group; and
performing a group-write operation, by the server, by writing the streaming content to the group based on a single fetching of the streaming content from a memory of the server.

9. The method according to claim 8,
wherein said grouping of the streaming content is performed in an application layer of the server.

10. The method according to claim 8, wherein grouping together the streaming content for said first client device and said second client device is performed when the frame boundaries of said first client device and said second client device are determined be within a predetermined range.

11. The method according to claim 10, wherein said predetermined range is a predetermined number of frames.

12. The method according to claim 10, wherein determining the frame boundaries of the streaming content for said first client device and said second client device occurs when a memory buffer of the server is rewritten with new streaming content.

13. The method according to claim 10, wherein said grouping together streaming content for said first client device and said second client occurs when a memory buffer of the server is rewritten with new streaming content that is different from previous streaming content.

14. The method according to claim 10, wherein said determination of frame boundaries for said streaming content of said first client device and said second client device is done by determining whether said frame boundaries are within a predetermined period of time of one another.

15. The method according to claim 10, wherein said determination of frame boundaries for said streaming content of said first client device and said second client device is done by determining whether or not said frame boundaries are within a predetermined number of frames of one another.

16. The method according to claim 8, further comprising:
receiving, by the server, a third request from a third client device for the streaming content;
providing streaming content, by the server, for the streaming content to said third client device;
determining, by the server, the frame boundaries of the streaming content for said third client device;
grouping together the streaming content, by the server, for said first, second, and third client device when the frame boundaries of said first, second, and third client device are determined to be within a predetermined range; and
not grouping together the streaming content for said third client device with said first and second client device when said third client device has frame boundaries that are not within a predetermined range of the frame boundaries of said first client device and said second client device.

17. A method of performing a group-write operation by a server to a plurality of sockets each associated with client devices connected to the server via a network, said method comprising:
determining, by the server, whether said plurality of client devices are to receive the same data from said server;
fetching data from a memory of said server a first time;
performing a group-write operation, by the server, to write said data to each client device based off of said first fetching of data from a memory.

18. The method of performing a group-write operation according to claim 17, wherein said determination is performed by a kernel of said server.

19. The method of performing a group-write operation according to claim 17, wherein said fetching data is performed by a kernel of said server.

20. The method of performing a group-write operation according to claim 17, further comprising:
fetching data from the memory of said server a second time;
performing a group-write operation, by the server, to write said data to each client device based off of said second fetching of data from a memory

21. The method according to claim 1, wherein the streaming content is a stream of live content.

22. The method according to claim 1, wherein the streaming content is a stream of pre-recorded content.
